(19) United States
(12) Patent Application Publication
(10) Pub. No.: US 2009/0139419 A1
(43) Pub. Date: Jun. 4, 2009

(54) Printing Plate Attaching Device

(76) Inventor: Andreas Zahnd, Zollikofen (CH)

Correspondence Address: RATNERPRESTIA, P.O. BOX 980, VALLEY FORGE, PA, 19482, US

(21) Appl. No.: 11/661,738

(22) PCT Filed: Jul. 6, 2005
(86) PCT No.: PCT/CH05/00383

§ 371 Date: Jan. 10, 2008

(30) Foreign Application Priority Data
Sep. 1, 2004 (DE) 10 2004 042 342.3

(51) Int. Cl. B41F 27/06

(52) U.S. Cl. 101/378

(57) ABSTRACT

A tensing means for a tensing channel of a cylinder body comprises a clamping piece for clamping a first cover end and for clamping a second cover end between the clamping piece and a tensing piece, wherein at least one contact region of the clamping piece and/or tensing piece, used to clamp a cover end or printing cylinder end, is formed to be roughly linear.

This application is the U.S. national phase application of PCT International Application No. PCT/CH2005/000383, filed Jul. 6, 2005, which claims priority to German Patent Application No. DE 10 2004 042 342.3, filed Sep. 1, 2004.

### BACKGROUND OF THE INVENTION

1. Technical Field

The invention relates to a printing plate attaching device and in particular to a device in which printing plates can be suspended or unhinged, preferably fully automatically, in a printing cylinder of a rotary printing machine, wherein a printing plate can be fastened to the printing cylinder in a clamp or fixed clamp.

2. Description of the Related Art

A suction device for handling printing blocks is for example known from U.S. Pat. No. 5,806,431. The suction device comprises a plurality of suckers next to each other along an axis and rollers arranged between them. In order to carry the printing block, the suckers are pressed onto the printing block such that each of the suckers forms a sealed suction chamber with the printing block. The suction chambers are charged with a vacuum, i.e. evacuated, thus generating the suction force necessary for carrying the printing block.

DE 10 2004 023 434.5, co-owned with the current application, discloses a suction device for a printing block of a printing machine or other exchangeable film of a film carrier which serves to transfer colour, wherein the teaching of DE 10 2004 023 434.5 with respect to attaching a sucker to a rotation machine, a suction device for holding a printing block of a printing machine and the method described therein for changing a printing block of a printing block carrier of a printing machine by means of a suction device is incorporated into this application.

U.S. Pat. No. 4,727,807 discloses a device for automatically attaching and removing printing plates of a rotary printing machine, which can be used in conjunction with the present invention.

Tensing or clamping means serve to tense one or more printing blocks or printing plates or other cylinder film, for example a rubber blanket, on a cylinder of a rotary printing machine. For this purpose, the relevant cylinder is provided with at least one tensing channel which extends axially on the surface of the cylinder and in which the tensing means is arranged. A tensing or clamping device such as the invention relates to is in particular required for rubber blanket cylinders and/or block cylinders of rotary printing machines, in order to fasten a rubber blanket or a flexible printing block, which are tensed onto a surface area of a cylinder, on the cylinder while maintaining the tension.

A clamping device for clamping a flexible cover of a cylinder of a printing machine is known from DE 102 44 944 A1 , co-owned with the current application.

### SUMMARY OF THE INVENTION

At least one embodiment of the present invention provides a clamping device for clamping a flexible cover of a cylinder of a printing machine, which enables the cylinder cover to be easily attached, securely clamped or held, and easily removed.

The tensing means in accordance with at least one embodiment of the invention can be inserted into a tensing channel of a printing cylinder, i.e. for example inserted from a lateral opening along the longitudinal axis of the printing cylinder, or inserted into a recess of the printing cylinder and for example fastened using a filling piece which covers the tensing means outwards such that only as small a tensing channel as possible for inserting ends of a cover, such as for example ends of a printing plate, is preferably open and the tensing means in accordance with the invention is arranged in the tensing channel beneath the opening slit of the tensing channel, in order to securely clamp the ends or hold them in a clamp.

An embodiment of the invention is described below for the application of depositing a printing plate, wherein however each flexible cover can be held using the described tensing means.

A tensing means in accordance with at least one embodiment of the invention comprises a tensing piece and a clamping piece which can preferably be shifted relative to each other, wherein when inserted into a tensing channel of a cylinder, one end of a cover, such as for example the leading end of a printing plate, can be clamped or held for example between an inner side or inner area of the tensing channel or an element fixedly connected to the cylinder and the clamping piece, while a second end of a cover, such as for example a trailing end of the same or another printing plate, is clamped or held between the clamping piece and the tensing piece. It is thus possible to avoid two plate ends lying directly on each other, which when removing one plate end of a plate in a plate change can for example easily cause the plate end of another plate, lying on said plate end, to be undesirably removed with it.

At least one contact area of the tensing piece and/or of the clamping piece is preferably formed such that when the clamping piece for example abuts an inner area of the tensing channel or an end of the printing plate lying on said inner side of the tensing channel on one side, a roughly linear contact exists, i.e. the clamping piece does not substantially abut two-dimensionally, but rather only has a narrow contact strip and ideally only a linear contact region which for example runs roughly parallel to the longitudinal axis of a printing cylinder, thus enabling a plate end to be more easily inserted and ejected.

Equally, the contact region between the clamping piece and the tensing piece can preferably be formed such that only a linear contact exists between the clamping piece and the tensing piece. A surface of the tensing piece and/or of the clamping piece can for example be formed such that an edge protrudes which is used for clamping a plate end. Equally, a surface of the clamping piece and/or of the tensing piece used for holding an inserted printing plate end can also be formed as a convex, outwardly arched or curved surface, thus enabling a linear contact to be established on a counter area which is for example flat or planar and level or is formed convexly or as an edge, such that plate ends can be easily inserted and ejected between said linear contact region but still securely held by a force lock or by clamping, wherein due to the reduction in the contact area, the pressing force is increased as compared to a two-dimensional clamping piece as known from the prior art.

The clamping piece and the tensing piece can preferably be shifted relative to each other, wherein for example a part of the clamping piece can be guided in the tensing piece and/or a part of the tensing piece can be guided in the clamping piece. A guiding element, for example in the form of a rod protruding from the clamping piece, can for example be provided on the clamping piece and for example screwed on, and can be inserted into a cavity, opening or guiding region (which can for example be formed as a groove) of the tensing piece, such that the clamping piece can only be moved in a direction predefined by the guiding element and the associated guide of the tensing piece. Equally, a guiding element can also be provided on the tensing piece which is guided by a corresponding guide of the clamping piece. It is also possible for a guiding element of the clamping or tensing piece to be only partially guided by for example a groove of the other piece in each case, wherein for example an inner area of the tensing channel, which the guiding element can abut, is used to further guide the guiding element and therefore the clamping or tensing piece.

A surface of the clamping piece and/or tensing piece which is used to clamp a plate end advantageously comprises at least one interruption, for example in the form of a recess or cavity, which can sub-divide the contact region of the clamping piece or tensing piece, which is for example formed linearly, into two or more separate contact regions with respect to the counter area, such that warping when clamping a plate end is reduced and can for example be more easily relieved by the interruption provided as a recess in the contact region, since sub-dividing the contact into two or more contact lines or contact regions increases the mobility of the clamping piece or tensing piece relative to a plate end, and a tension created by an inclination between two abutting elements can for example be more easily released, since there is then only a smaller contact region which however still enables a plate end to be securely clamped or held due to the greater pressing force.

Advantageously, the clamping piece and/or tensing piece is substantially not deformable, i.e. formed as a non-elastic and preferably rigid or stiff element for example from a substantially non-elastic material such as for example metal, such that a roughly linear contact region, which for example extends roughly parallel to the longitudinal axis of the cylinder when inserted into a printing block cylinder, can be realised under pressure without a two-dimensional contact region resulting. Equally, however, it is also possible for the clamping piece, the tensing piece or the clamping and tensing piece to comprise at least one partial region which is formed from an elastic material such as for example rubber.

A tensing element, such as for example a spring or an elastic element, is preferably provided, using which a pressure between the tensing piece and the clamping piece can be generated for clamping a plate end and/or a pressure between the clamping piece and a counter area, for example an inner area of the tensing channel, can be generated for clamping another plate end, independently of clamping the first plate end. A spring can for example be provided which is supported against an inner side of a tensing channel and presses the tensing piece from this inner side of the tensing channel towards the clamping piece, such that said spring generates a pressure between the clamping piece and the tensing piece and between the clamping piece and another piece or the inner side of the tensing channel, whereby two plate ends, which are for example inserted on two opposite sides of the clamping piece, can for example be clamped by the pressure from the tensing element, wherein when one or two plate ends are inserted, the clamping piece and the tensing piece are for example moved away from each other and together towards the tensing element, such that the tensing element generates a counter force which is large enough to hold the inserted plate ends.

The tensing means in accordance with the invention preferably comprises a filling piece which is for example inserted into a recess or cavity of a printing cylinder over the tensing means inserted into the printing cylinder, in order to only provide as small a channel as possible above the tensing means for inserting the plate ends, wherein the tensing piece is preferably almost completely covered by the filling piece.

In accordance with another aspect, the invention relates to a printing block cylinder, for example for a rotary printing machine, into which at least one tensing means as described above can be or has been inserted, wherein it is advantageous to provide at least two tensing means in accordance with the invention, each consisting of at least one clamping piece and at least one tensing piece, in order to hold an end or partial region of an end of a printing plate in each case, wherein for example a right-hand plate end arranged to the right of a register opening of the printing plate is held or clamped by a first tensing means, and a left-hand plate end arranged to the left of a register opening of the printing plate is held or clamped by a second tensing means. It is equally possible to provide three, four or more than four tensing means for holding an end of a printing plate, wherein using a plurality of tensing means which are separate from each other in their function, while more complex in production terms, does however enable a printing plate end to be more easily inserted and removed, since the danger of jamming is reduced.

The invention further relates to the combination of a printing cylinder as described above and a robot, such as is for example known from U.S. Pat. No. 4,727,807, for automatically attaching and/or removing a printing plate.

In accordance with another aspect, the invention relates to a method for manufacturing a printing plate cylinder comprising a tensing means as described above, wherein a recess is provided in the printing cylinder, into which a tensing element is inserted which is supported against the cylinder or an element abutting the cylinder, such as for example a filling piece, or into which a tensing piece and a clamping piece are inserted such that they are movably mounted and form one or two linear abutment regions into which two plate ends can be inserted separately from each other, against the force of the tensing element.

### BRIEF DESCRIPTION OF THE DRAWINGS

The invention is further explained on the basis of an example embodiment and by referring to the figures below, which show:

FIG. 1 is a cross-sectional view illustrating a tensing means in accordance with an exemplary embodiment of the invetion inserted into a printing block cylinder;

FIG. 2 is a top view onto a printing block cylinder, together with a printing plate to be suspended;

FIG. 3 is an enlarged representation of the tensing means shown in FIG. 1;

FIG. 4 is an isometric view of an embodiment of a clamping piece; and

FIG. 5 is a schematic representation of the mode of operation of the tensing means shown in FIG. 1.

### DETAILED DESCRIPTION

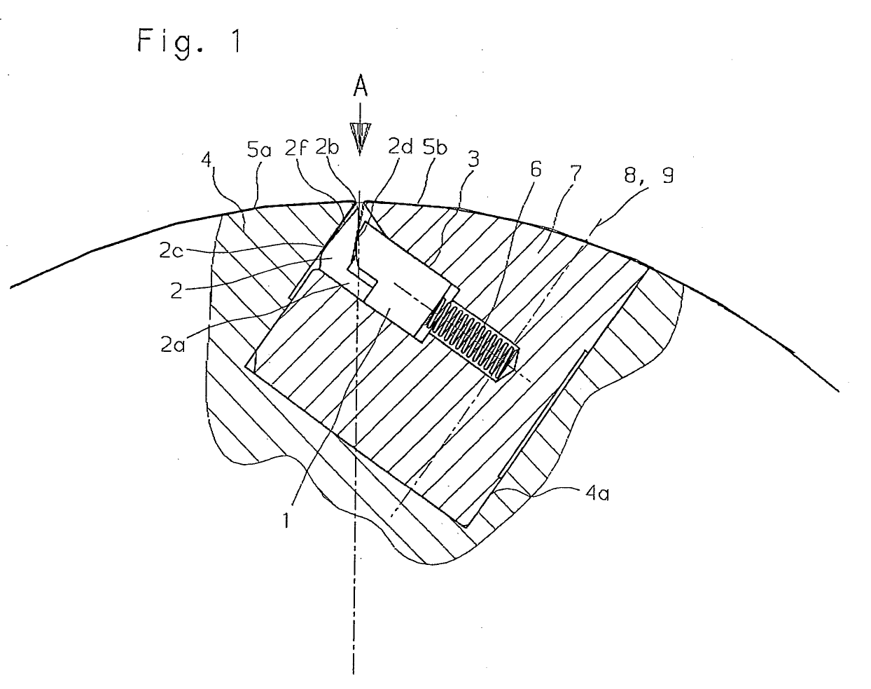

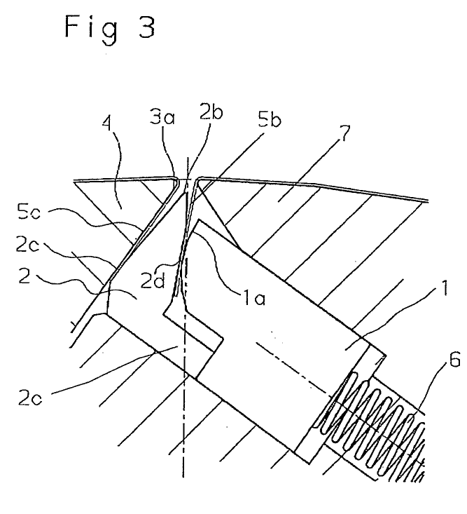

FIGS. 1 and 3 show a printing cylinder 4 which comprises a milled edge 4a in which a filling piece 7, which carries a tensing means consisting of a tensing piece 1, a clamping piece 2 and a spring 6 serving as a tensing element, is inserted and fixed to the cylinder 4 by means of a screw 8. In the tensing channel 3 defined by the filling piece 7 and an inner wall of the cylinder 4, which towards the outer side of the printing cylinder 4 has a tensing slit 3a for inserting a leading end 5a of a first printing plate and a trailing end 5b of a second printing plate, the clamping piece 2 is inserted with the guiding element 2a which protrudes from the clamping piece 2 and is fixedly connected to the clamping piece 2, such that an even area (in the example embodiment) or also an abutment side 2c, formed convex or curved, of the clamping piece 2 linearly abuts an inner side of the tensing channel 3, roughly parallel to the longitudinal axis of the cylinder 4, such that the end 5a of one printing plate is inserted between the inner side of the cylinder 4 and the clamping piece 2 and held by the linear contact, wherein the clamping piece 2 is pressed against the inner side of the tensing channel 3 by the force of the spring 6, in order to hold the end 5a of the printing plate.

On the side facing the tensing slit 3a, the clamping piece 2 comprises a separating element 2b formed for example as an edge and, in the embodiment shown in FIG. 1, an inclined area 2f shown to the left of the tip in FIG. 1, such that the end 5a can be securely guided into the clamping position shown. The side 2g of the clamping piece 2 opposite the side 2c used for clamping the plate end 5a is formed as a plane and substantially non-curved area in the embodiment shown and serves to guide a plate end 5b which is held or fixedly clamped by a convex area 1a of the tensing piece 1, such that since the area 1a of the tensing piece 1 for holding the plate end 5b is formed to be convex or slightly curved outwards, a linear contact region exists.

The pressure of the spring 6 both clamps the plate end 5a and fixedly clamps the plate end 5b which do not contact each other when inserted and clamped and thus can be inserted or removed independently of each other without there being any danger of the other plate end being moved with it.

On the side opposite the tensing slit 3a, the tensing piece 1 and the clamping piece 2 have roughly flat upper sides and can thus be moved along the tensing channel 3, wherein the clamping piece 2 is guided by the guiding element 2a which engages with the a cavity of the tensing piece 1, thus also preventing the clamping piece 2 from being removed from the tensing channel 3.

A journal 9 made of brass (shown only as a dot-dash line in FIG. 1) is for example provided over the screw 8 provided for fastening the filling piece 7 or the tensing means guided in it, wherein once the filling piece 7 has been inserted and fastened together with the tensing means 1, 2, 6, it is possible to polish over the surface of the cylinder in order to obtain a smooth surface.

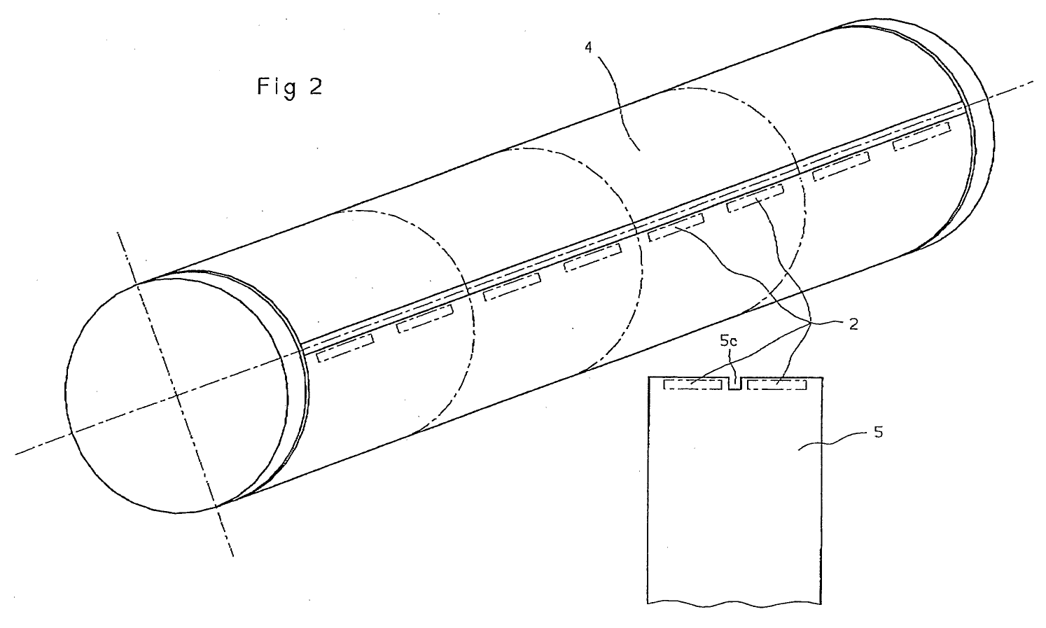

FIG. 2 shows a top view onto a cylinder 4, into which for example four printing plates 5, each having a register opening 5c, can be inserted next to each other, wherein it is also possible for example to suspend two panorama plates, each formed to be roughly twice as wide as a printing plate 5, wherein due to the tensing means—which in accordance with the invention is formed without a lateral delimitation, substantially extends over the entire length of the cylinder 4 and consists of a plurality of individual tensing pieces 1, clamping pieces 2 and springs 6—a large degree of freedom results with respect to the width of plates which can be suspended and securely and fixedly clamped.

In the embodiment shown in FIG. 2, two mutually independent clamping pieces 2 are provided for holding an end of a printing plate, wherein a register means can be provided in the region between the tensing means or between the clamping pieces 2, as for example described in DE 10 2004 023 008.0, co-owned with the current application, the teaching of which with respect to forming such a register means is incorporated into this application.

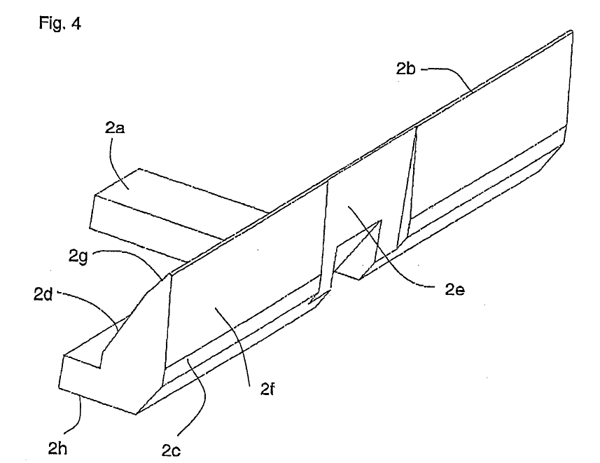

FIG. 4 shows an enlarged representation of a clamping piece 2 comprising a guiding element 2a which is milled from solid or screwed onto it and which is level on its lower side 2h and exhibits an equally level area 2f on its side opposite the guiding element 2a, said area 2i being roughly perpendicular on the lower side 2h. The edge 2b provided on the upper side of the clamping piece 2 acts as a separating element and separates the convexly formed rear side 2c of the clamping piece 2 from the clamping side 2d which is formed as a level incline and interrupted by a sub-division 2e retracted for example by 1 mm. Such an interruption 2e can equally be provided in the convex surface 2c formed on the rear side 2c of the clamping piece 2.

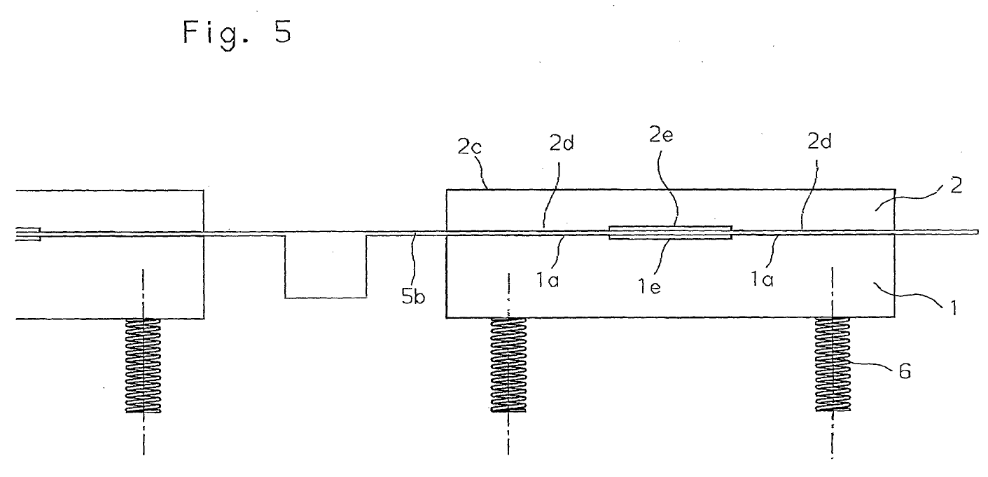

FIG. 5 schematically shows the functional principle of the tensing means in a top view onto the tensing means shown in FIG. 1, from the direction of the arrow A. The clamping areas 1a and 2d of the tensing piece 1 or clamping piece 2, interrupted by the retracted areas 1e and 2e, are pressed onto each other by the force of the spring acting on the tensing piece 1 and can thus hold the plate end 5b of a printing plate, wherein since the clamping piece 2 is formed tapered, the clamping piece 2 is pressed radially outwards when the cylinder 4 is rotated and thus together with the force of the spring 6, it is ensured that the printing plate ends 5a and 5b held fixedly on the two outer areas 2c and 2d of the clamping piece 2 are securely clamped.

### LEGEND

1 tensing piece

1a clamping area of the trailing plate end

1e cavity
2 clamping piece

2a guiding spike

2b separating edge

2c clamping area of the leading plate end

2d clamping area of the trailing plate end

2e cavity

2f guiding area of the leading plate end

2g guiding area of the trailing plate end

2h lower side of the clamping piece
3 tensing channel

3a tensing slit
4 cylinder

4a milled edge
5 printing plate

5a leading plate end

5b trailing plate end

5c register slit
6 pressure spring
7 filling piece
8 screw
9 journal

1. A tensing means for a tensing channel of a cylinder body comprising: a clamping piece for clamping a first cover end against an abutment area and for clamping a second cover end between the clamping piece and a tensing piece, wherein at least one contact region of the clamping piece, the tensing piece, or both the clamping piece and the tensing piece is formed to be roughly linear.

2. The tensing means according to claim 1, wherein the clamping piece can be shifted relative to the tensing piece.

3. The tensing means according to claim 1, wherein the tensing piece, the clamping piece, or both the tensing piece and the clamping piece, comprises an even or level area.

4. The tensing means according to claim 1, wherein the clamping piece comprises a separating element together with a guiding area for guiding an end of a cover or printing plate.

5. The tensing means according to claim 1, wherein at least one clamping area of the tensing piece, the clamping piece, or both the tensing piece and the clamping piece, comprises an interruption.

6. The tensing means according to claim 1, wherein the tensing piece, the clamping piece, or both the tensing piece and the clamping piece, is made from a non-elastic material.

7. The tensing means according to claim 1, further comprising at least one tensing element which presses onto the tensing piece, the clamping piece, or both the tensing piece and the clamping piece.

8. A printing block cylinder comprising a tensing means according to claim 1.

9. The printing block cylinder according to claim 8, further comprising a filling piece in which the tensing means is at least partially inserted.

10. The printing block cylinder according to claim 8, wherein at least two tensing means are provided for holding an end of a cover or printing plate.

11. A method for manufacturing a printing plate cylinder comprising the steps of: providing a recess in the printing cylinder; inserting at least one tensing element into the recess such that it is supported against the cylinder or an element abutting the cylinder; and inserting at least one tensing piece and at least one clamping piece into the recess such that they are movably mounted and form at least one linear abutment region into which at least one plate end can be inserted, against the force of the tensing element.

12. The tensing means according to claim 1, wherein the tensing piece, the clamping piece, or both the tensing piece and the clamping piece comprises a convex or outwardly curved surface.

13. The tensing means according to claim 1, wherein the at least one contact region is used to clamp a cover end or a printing cylinder end.

14. The method according to claim 11, wherein the element abutting the cylinder is a filling piece.
